(19) United States
(12) Patent Application Publication
(10) Pub. No.: US 2022/0240634 A1
(43) Pub. Date: Aug. 4, 2022

(54) Combination 5G Protection Fabric and Device

(71) Applicant: Vincent Oliveri, XMechanicville, NY (US)

(72) Inventor: Vincent Oliveri, XMechanicville, NY (US)

(21) Appl. No.: 17/588,527

(22) Filed: Jan. 31, 2022

Related U.S. Application Data
(60) Provisional application No. 63/144,841, filed on Feb. 2, 2021.

(51) Int. Cl. A45B 25/18; H01Q 1/52; B62B 7/00; A45B 23/00

(52) U.S. Cl. CPC A45B 25/18; H01Q 1/526; A45B 2023/0006; A45B 23/00; A45B 2025/183; B62B 7/00

(57) ABSTRACT

The present invention relates to a multipurpose shielding or attenuating fabric for blocking up to 99.9% of an electromagnetic field (EMF) and RFID radiating from 5G and other cellular towers. The fabric can be used in strollers, pet carriers, umbrellas, and other devices for protecting from 5G radiation. The fabric can also include an integrated 5G detection chip for detecting 5G radiation impinging on the fabric. The fabric includes shielding particles woven into the fabric for shielding from 5G radiation. The fabric, configured into various device embodiments, protects adults, children, and pets from the harmful effects of 5G radiation and eliminates the need to keep a child or pet indoors.

### CROSS-REFERENCE TO RELATED APPLICATION

The present application claims priority to, and the benefit of, U.S. Provisional Application No. 63/144,841, which was filed on Feb. 2, 2021 and is incorporated herein by reference in its entirety.

### FIELD OF THE INVENTION

The present invention relates generally to the field of 5G radiation shielding devices positioned on a device, such as a stroller, umbrella, sunshade or the like. More specifically, the invention relates to a 5G shielding fabric configured for blocking up to 99.9% of EMF, EMI and RFID that emanate from 5G and other cellular towers. The fabric can be used with other materials for making strollers, pet carriers, umbrellas, and other devices. The fabric is weatherproof and includes shielding material for attenuating the effects of 5G radiation. The fabric enables individuals to enjoy the outdoors and not worry about the effects of 5G on children, pets, and adults. Accordingly, the present disclosure makes specific reference thereto. Nonetheless, it is to be appreciated that aspects of the present invention are also equally applicable to other like applications, devices and methods of manufacture.

### BACKGROUND

By way of background, electric, magnetic and electromagnetic fields, rays, radiation, waves and wave particles, hereinafter referred to generically as “electromagnetic fields”, EMFs or “electromagnetism”, surround us in everyday life. With the advancements in cellular technologies, exposure of humans and animals to these fields has increased. In particular, with the deployment of the latest 5G cellular technology, which was launched by major global operators in 2019, intensity of the exposure to electromagnetic fields (EMFs) has started producing negative health effects.

5G stands for “fifth generation” and works by using higher frequencies than previous wireless networks such as 4G and 3G, making 5G faster and more efficient. The frequencies used by 5G range from 3.5 gigahertz (GHz) to several tens of GHz. Before 5G was launched, these higher frequencies were not used in mobile networks. Electromagnetic frequencies, like those produced by 5G, create an area called an electromagnetic field (EMF). 5G technology is effective only over short distances. It is poorly transmitted through solid material and therefore, many new antennas are required and full-scale implementation results in antennas every 10 to 12 houses in urban areas, thus massively increasing mandatory, ambient and/or passive exposure.

It has been determined in studies that EMF can cause tissue heating. This tissue heating is low and minimal, however, with the presence of 5G cellular towers around the world and radiating 5G radiation, humans and animals are continuously absorbing these EMF waves which can be detrimental to their health. Another study also suggested that a causal interpretation between mobile phone RF-EMF exposure and glioma is possible, and this may increase when the mobile phone uses 5G EMF. Also, the developing nervous system in children is more conductive and absorbs more electromagnetic energies than that of adults.

Individuals and regulatory authorities desire a way so that individuals, children, and pets can enjoy the outdoors without worrying about the negative effects of EMF caused by cellular technologies especially 5G. A 5G protection layer which can be used within materials of various fabrics and devices is desired by individuals as the smartphone cases that individuals typically use can help in reducing radiation from the phone but not from cellular towers.

Therefore, there exists a long felt need in the art for an EMF protection fabric which can be used within materials of a stroller, umbrella and others for providing protection from EMF waves caused from cellular technologies. There is also a long felt need in the art for a multipurpose fabric that protects adults, children, and pets from harmful 5G radiation. Additionally, there is a long felt need in the art for a 5G protection means that reduces exposure from 5G radiation radiating and emanating from cellular towers. Moreover, there is a long felt need in the art for a 5G protection method that allows individuals to enjoy the outdoors without worrying about 5G radiation. Further, there is a long felt need in the art for 5G protection fabrics that eliminates EMF absorption by humans, children and pets. Finally, there is a long felt need in the art for a 5G protection layer that blocks up to 99.9% of EMF, EMI and RFID that emanates from 5G.

The subject matter disclosed and claimed herein, in one embodiment thereof, comprises 5G electromagnetic field shielding fabric. The fabric can be used as a 5G protection layer within materials used for a stroller, a carriage, an umbrella, and other devices. The fabric can comprise various sizes, designs and colors. The fabric includes a weatherproof layer, a plurality of shielding particles/wires woven into the fabric, the shielding particles are made from one or more of nickel, copper, silver, zinc, chromium, or carbon-based compounds for attenuating the effects of 5G EMF and an integrated chip for detecting 5G EMF impinging on the fabric.

In this manner, the multipurpose weatherproof 5G electromagnetic field shielding fabric of the present invention accomplishes all of the forgoing objectives and provides users with a weatherproof fabric which can be used for reflecting harmful 5G radiation. The fabric can be used as a material for use with, for example umbrellas, strollers and children's carriers for protecting adults, children and pets from 5G radiation. The fabric can be flexible and tear resistant and can be used for a variety of purposes enabling individuals to enjoy the outdoors without worrying about 5G exposure.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises 5G electromagnetic field shielding fabric. The fabric can be used as a 5G protection layer within flexible materials used with, for example strollers, carriages, umbrellas and other devices. The fabric includes a weatherproof layer, a plurality of shielding particles/wires woven into the fabric, the shielding particles are made from one or more of nickel, copper, silver, zinc, chromium or carbon-based compounds for attenuating the effects of 5G EMF, and an integrated chip for detecting 5G EMF impinging on the fabric.

In yet another embodiment, a 5G EMF attenuating stroller for carrying a child is disclosed. The stroller includes a sunshade for protecting the child from sun and other weather elements, the sunshade includes a layer of 5G electromagnetic field shielding fabric for blocking up to 99.9% of EMF, EMI and RFID that emanate from 5G and other cellular towers.

In yet another embodiment, a 5G EMF attenuating pet carrier is disclosed. The pet carrier includes a sunshade for protecting the pet from sun and other weather elements, the sunshade includes a layer of 5G electromagnetic field shielding fabric for blocking up to 99.9% of EMF, EMI and RFID that emanates from 5G and other cellular towers.

In yet another embodiment, a fabric designed for blocking up to 99.9% of EMF, EMI, and RFID coming from 5G towers is disclosed. The fabric includes 5G shielding material for shielding EMF, EMI, and RFID coming from 5G towers, a 5G detection chip for detecting a value of EMF, EMI and RFID impinging on the fabric from 5G towers wherein the chip is further configured to transmit the detected value to a paired smartphone application.

In yet another embodiment, the 5G shielding material includes 60% polyester, 20% cotton and 20% EMF shielding material. The composition allows the material to be suitable for a variety of purposes without reducing the efficacy of attenuating 5G EMF.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of 5G electromagnetic field shielding material in accordance with the disclosed architecture;

FIG. 2 illustrates a perspective view of one potential embodiment of a foldable canopy with electromagnetic shielding clothing of the present invention in accordance with the disclosed architecture;

FIG. 3 illustrates a perspective view showing the electromagnetic field shield canopy of the present invention attached to a stroller in accordance with the disclosed architecture;

FIG. 4 illustrates a perspective view of a potential embodiment of a 5G EMF attenuating pet carrier of the present invention in accordance with the disclosed architecture; and

FIG. 5 illustrates a block diagram view showing communication of another embodiment of the 5G EMF attenuating fabric with a paired smartphone in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an EMF protection fabric which can be used within materials of, for example a stroller, an umbrella and others for providing protection from EMF waves caused from cellular technologies (i.e. towers). There is also a long felt need in the art for a multipurpose fabric that protects adults, children, and pets from harmful 5G radiation. Additionally, there is a long felt need in the art for a 5G protection means that reduces exposure from 5G radiation radiating and emanating from cellular towers. Moreover, there is a long felt need in the art for a 5G protection method that allows individuals to enjoy the outdoors without worrying about 5G radiation. Further, there is a long felt need in the art for 5G protection fabrics that eliminate EMF absorption by humans, children and pets. Finally, there is a long felt need in the art for a 5G protection layer that blocks up to 99.9% of EMF, EMI and RFID that emanates from 5G.

The present invention, in one exemplary embodiment, comprises a novel fabric designed for blocking up to 99.9% of EMF, EMI and RFID coming from 5G and other cellular towers. The fabric includes 5G shielding material for shielding EMF, EMI and RFID coming from 5G towers, a 5G detection chip for detecting the value of EMF, EMI, and RFID impinging on the fabric from 5G towers wherein the chip is further configured to transmit detected value to a paired smartphone application.

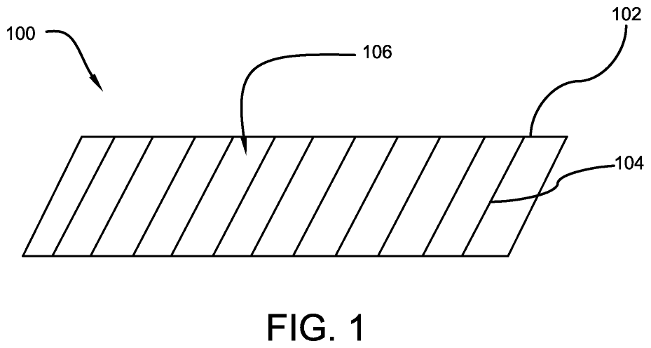

Referring initially to the drawings, FIG. 1 illustrates a perspective view of 5G electromagnetic field shielding material in accordance with the disclosed architecture. As shown, the 5G electromagnetic field shielding fabric 100 is in the form of a conventional fabric and can be used for manufacturing materials used in, for example umbrellas, strollers/carriers, sunshades and other devices. The fabric 100 may also be used for making wearable clothing. More specifically, the fabric 100 can be a polyester/nylon blend 102 and includes shielding particles/wires 104 made from one or more of nickel, copper, silver, zinc, chromium or carbon-based compounds. The upper layer 106 is weatherproof and thus the shielding particles 104 woven into the fabric 100 are not affected due to inclement weather. The shielding particles 104 can be uniformly woven into the fabric 100, thus providing a uniform EMF attenuating capability. The fabric 100 can have a thickness in the range from about 1 mm to about 3 mm.

The fabric 100 is designed such that it can be stitched with any other fabric and therefore, can be used for a variety of purposes for providing effective protection by blocking up to 99.9% of EMF, EMI and RFID that emanates from 5G. In one potential embodiment, the fabric 100 can include from about 50% to about 70% polyester and nylon blend, from about 10% to about 30% cotton, and from about 10% to about 30% EMF shielding material. The composition allows the fabric 100 to be suitable for a variety of purposes without reducing the efficacy of attenuating 5G EMF. The fabric 100 can come in a variety of colors, designs and textures to fit in a plurality of requirements.

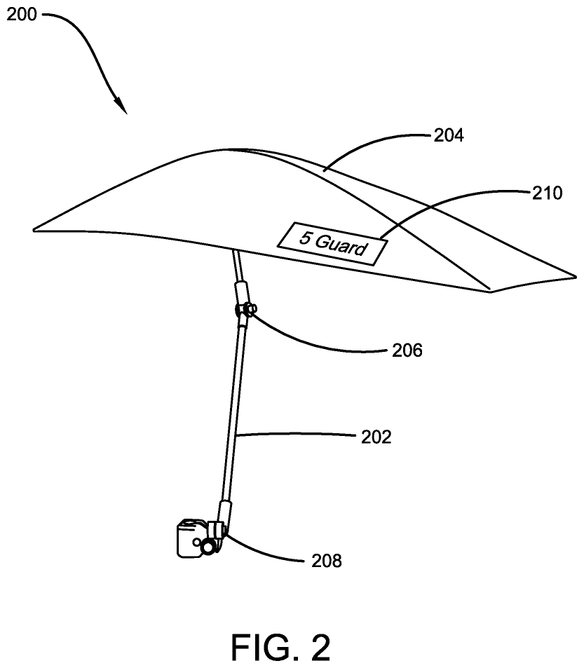

FIG. 2 illustrates a perspective view of one potential embodiment of a foldable canopy with electromagnetic shielding material of the present invention in accordance with the disclosed architecture. The foldable canopy 200 is configured to be foldable, allowing the canopy 200 to be easily stored by a user and can be removably attached to, for example a stroller or carrier. The canopy 200 includes a telescoping shaft 202 which can be extended or retracted in length as per the preferences of a user. The canopy panel 204 is made from electromagnetic field (EMF) shielding fabric of the present invention and is configured to shield electromagnetic and radio frequency radiations, and does not allow same to pass radiations therethrough, therefore protecting a user positioned below the panel 204 from electromagnetic and radio frequency radiations. A tilting hinge 206 enables the canopy panel 104 to tilt in a desired direction for providing further protection from weather elements.

More specifically, the canopy panel 204 is a weatherproof electromagnetic shielding fabric 100 shown in FIG. 1. The weatherproof property makes the fabric/panel 204 water repellant and provides conventional protection from snow, rain and sunrays. The electromagnetic shielding fabric panel 204 is configured to reflect electromagnetic and radiofrequency waves originating from 5G cellular towers and other cellular towers. The panel 204 includes shielding particles woven into the fabric and the shielding particles may include one or more of nickel, copper, silver, zinc, chromium or carbon-based compounds. The shielding material particles are configured to re-radiate or reflect electromagnetic and radiofrequency waves impinging on the canopy panel 204 to protect a user below the canopy panel 204.

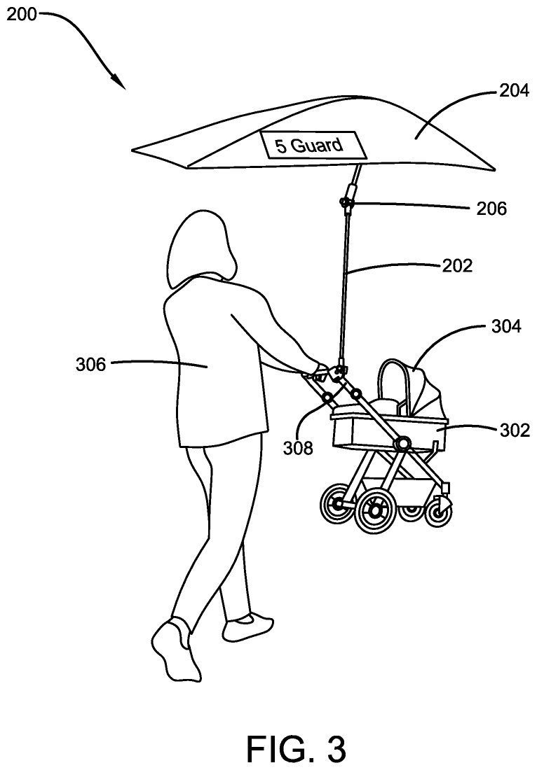

The canopy panel 204 can be stitched together to any other layer of fabric for providing additional protection of weather elements. The canopy shaft 202 includes a handle 208 for removably attaching the canopy 200 to any stroller or carriage for protecting a user such as a parent while taking a child for a walk outside as best shown in FIG. 3. The canopy 200 also protects the child in the stroller from harmful electromagnetic and radiofrequency waves originating from 5G cellular towers. The canopy panel 204 can have a logo or any other indicia 210 for branding and marketing purposes. In one potential embodiment, the logo 210 can include the trademark “5Guard” which can be sewn or permanently attached through an adhesive on the panel 204.

FIG. 3 illustrates a perspective view showing the electromagnetic field shield canopy 200 of the present invention attached to a stroller 302 in accordance with the disclosed architecture. The canopy 200 is attached to the handle 308 of the stroller 302 such that the EMF shielding canopy panel 204 covers the user 306 pushing the stroller 302 and a child lying in the stroller 302. The canopy panel 204 blocks up to 99.9% of EMF, EMI, and RFID that emanates from 5G and cellular towers and other sources and protects both the user 306 and the child from exposure. As described in FIG. 2, the canopy panel 204 can be adjusted in length and orientation using the telescoping shaft 202 and the tilting hinge 206.

The stroller 302 includes an electromagnetic field shielding sunshade 304 that is made from EMF shielding fabric from which the canopy panel 204 is manufactured. The sunshade 304 protects the child in the stroller 302 by blocking up to 99.9% of EMF, EMI and RFID that emanates from 5G and cellular towers and other sources.

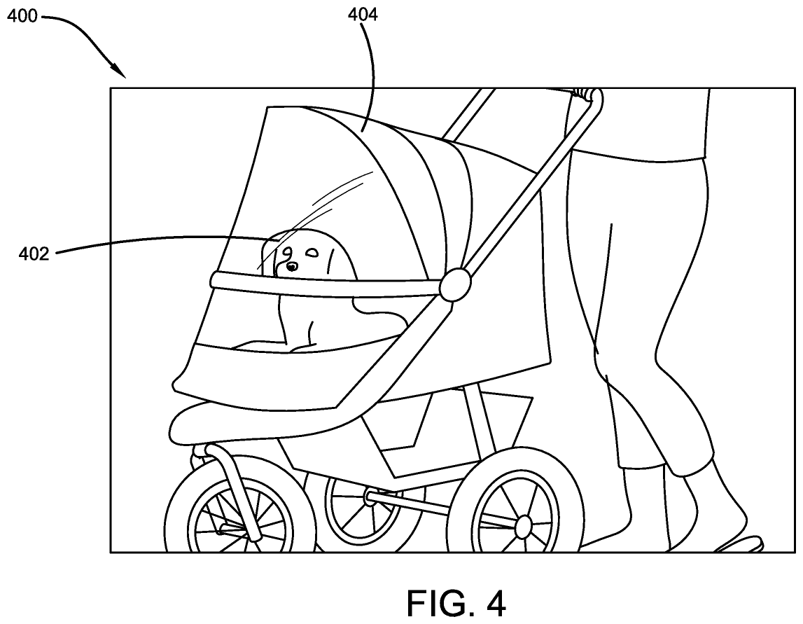

FIG. 4 illustrates a perspective view of a potential embodiment of a 5G EMF attenuating pet carrier of the present invention in accordance with the disclosed architecture. The 5G EMF attenuating pet carrier 400 is manufactured using one or more layers of the EMF shielding material/fabric 100 of the present invention and is designed to protect the pet 402 sitting in the carrier 400 from harmful EMF, EMI, and RFID that emanates from 5G and other cellular towers. The carrier 400 is designed to perform conventional tasks of a carrier in addition to providing EMF shielding for the pet. As shown, the sunshade 404 protects the pet 402 from harmful radiations caused due to 5G.

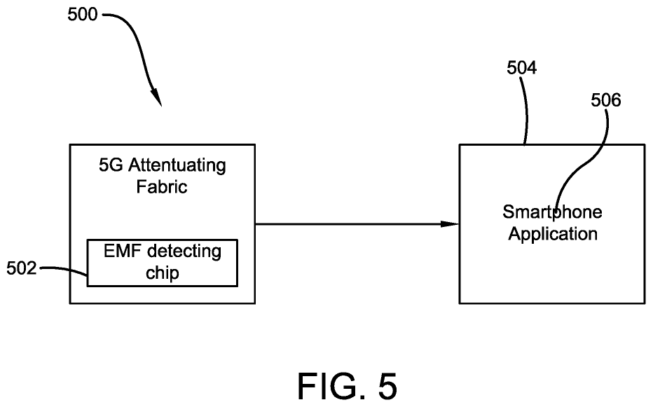

FIG. 5 illustrates a block diagram view showing communication of another embodiment of the 5G EMF attenuating fabric with a paired smartphone in accordance with the disclosed architecture. The 5G EMF attenuating fabric 500 of the present embodiment includes a built-in EMF detecting chip 502 that is configured to detect 5G EMF impinging on the fabric 500. The fabric 500 includes the same properties of attenuating and shielding 5G EMF as of the fabric 100 described in FIG. 1. The chip 502 is configured to connect to a smartphone application 506 installed in a handheld electronic device 504 and the chip 502 transmits the 5G EMF information to the application 506. The application 506 is configured to provide a visual or audible notification in case the chip 502 detects 5G EMF, thus alerting a user to be cautious of the 5G EMF exposure.

In a further embodiment, the chip 502 can transmit the 5G EMF power impinging on the fabric 500 to the smartphone application 506 indicating to the user about the potential hazard.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “5G EMF attenuating fabric”, “5G EMF attenuating material”, “5G electromagnetic field shielding material”, “fabric” and “material” are interchangeable and refer to the 5G electromagnetic field shielding material 100,500 of the present invention.

Notwithstanding the forgoing, the 5G electromagnetic field shielding material 100,500, stroller 302 and pet carrier 400 of the present invention can be of any suitable size and configuration as is known in the art without affecting the overall concept of the invention, provided that it accomplishes the above-stated objectives. One of ordinary skill in the art will appreciate that the 5G electromagnetic field shielding material 100,500, stroller 302 and pet carrier 400 as shown in the FIGS. are for illustrative purposes only, and that many other sizes and shapes of the 5G electromagnetic field shielding material 100,500, stroller 302 and pet carrier 400 are well within the scope of the present disclosure. Although the dimensions of the 5G electromagnetic field shielding material 100,500, stroller 302 and pet carrier 400 are important design parameters for user convenience, the 5G electromagnetic field shielding material 100,500, stroller 302 and pet carrier 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” can be used in either the detailed description or the claims, such term is intended to be inclusive in a manner similar to the term “comprising” as “comprising” is interpreted when employed as a transitional word in a claim.

What is claimed is:

1. An electromagnetic field (EMF) shield device, the EMF shield device comprising:
a shielding fabric having a first shielding layer and a second outer layer;
wherein said first shielding layer comprises a material of polyester and nylon blend and further comprises a plurality of particles selected from a group consisting of a nickel, a copper, a silver, a zinc and a chromium;
wherein said plurality of particles are uniformly woven into said first shielding layer;
wherein said second outer layer is waterproof;
wherein said shielding fabric includes a thickness in the range from about 1 mm to about 3 mm; and
further wherein said shielding fabric is attached to a device selected from a group consisting of an umbrella, a stroller and a sunshade.

2. The EMF shield device of claim 1, wherein said device includes a foldable canopy.

3. The EMF shield device of claim 1, wherein said device includes a pet carrier.

4. The EMF shield device of claim 2, wherein said foldable canopy includes a telescoping shaft.

5. The EMF shield device of claim 4, wherein said telescoping shaft includes a tiltable hinge.

6. The EMF shield device of claim 1, wherein said device includes wearable clothing.

7. The EMF shield device of claim 1, wherein said first shielding layer further comprising a material of cotton.

8. The EMF shield device of claim 7, wherein said first shielding layer comprises from about 50% to about 70% said polyester and nylon blend, from about 10% to about 30% said cotton, and from about 10% to about 30% said particles.

9. The EMF shield device of claim 8, wherein said particles include carbon-based compounds.

10. The EMF shield device of claim 1, wherein said shielding fabric includes a built-in EMF detecting chip for detecting 5G EMF impinging on said shielding fabric.

11. The EMF shield of claim 10, wherein said detecting chip connected to a smartphone application for transmitting the 5G EMF impinging on said shielding fabric.

12. The EMF shield of claim 11, wherein said smartphone application provides an audible notification when said detecting chip is detecting the 5G EMF impinging on said shielding fabric.

13. An electromagnetic field (EMF) shield device, the EMF shield device comprising:
a shielding fabric having a first shielding layer and a second outer layer;
wherein said first shielding layer comprising a material of polyester and nylon blend and further comprising particles selected from a group consisting of a nickel, a copper, a silver, a zinc, a chromium, and a carbon-based compound;
wherein said particles are uniformly woven into said first shielding layer;
wherein said first shielding layer further comprising a material of cotton;
wherein said second outer layer is waterproof;
wherein said shielding fabric includes a thickness in the range from about 1 mm to about 3 mm;
wherein said first shielding layer comprises from about 50% to about 70% said polyester and nylon blend, from about 10% to about 30% said cotton, and from about 10% to about 30% said particles; and
further wherein said shielding fabric includes material for a device selected from a group consisting of an umbrella, a stroller, a pet carrier, and a sunshade.

14. The EMF shield device of claim 13, wherein said device includes a foldable canopy.

15. The EMF shield of claim 13, wherein said shielding fabric includes material for wearable clothing.

16. An electromagnetic field (EMF) shield device, the EMF shield device comprising:
a shielding fabric having a first shielding layer and a second outer layer;
wherein said first shielding layer comprising a material of polyester and nylon blend, and particles selected from a group consisting of a nickel, a copper, a silver, a zinc, a chromium and a carbon-based compound;
wherein said particles are uniformly woven into said first shielding layer;
wherein said first shielding layer further comprising a material of cotton;
wherein said second outer layer is waterproof;
further wherein said first shielding layer comprises from about 50% to about 70% said polyester and nylon blend, from about 10% to about 30% said cotton, and from about 10% to about 30% said particles; and
further wherein said shielding fabric includes a built-in EMF detecting chip for detecting 5G EMF impinging on said shielding fabric.

17. The EMF shield device of claim 16, wherein said detecting chip connected to a smartphone application for transmitting the 5G EMF impinging on said shielding fabric.

18. The EMF shield device of claim 17, wherein said smartphone application provides an audible notification when said detecting chip is detecting the 5G EMF impinging on said shielding fabric.

19. The EMF shield device of claim 18, wherein said particles include carbon-based compounds.

20. The EMF shield device of claim 16, wherein said shielding fabric includes material for a device selected from a group consisting of an umbrella, a stroller, a pet carrier, and a sunshade.
